(19) United States
(12) Patent Application Publication
(10) Pub. No.: US 2006/0010182 A1
(43) Pub. Date: Jan. 12, 2006

(54) Quantum random number generator

(76) Inventors: Joseph B. Altepeter, Urbana, IL (US); Evan Jeffrey, Champaign, IL (US); Paul G. Kwiat, Champaign, IL (US)

Correspondence Address: BROMBERG & SUNSTEIN LLP, 125 SUMMER STREET, BOSTON, MA, 02110-1618, US

(21) Appl. No.: 10/885,503

(22) Filed: Jul. 6, 2004

(51) Int. Cl. G06F 1/02; G06F 7/58

(52) U.S. Cl. 708/250

(57) ABSTRACT

A method and apparatus for generating random numbers. Events characteristic of a random process are registered, and a particular time segment, from among a set of time segments, is identified based upon registration of an event within that time segment, and a value is associated based on the identified time segment. The events may be detections of a particle by a particle detector such as a photon detector. A random number is outputted based at least upon the associated value. Outputting of the random numbers may be followed by a whitening process. The source of particles may be driven to provided various specified probability distributions of values.

This invention was developed with Government support under Contract Numbers DAAD19-03-1-0199 and DAAD19-03-1-0282 awarded by the United States Army Research Office. The Government has certain rights in the invention.

### TECHNICAL FIELD AND BACKGROUND ART

The present invention pertains to methods and apparatus for generating random numbers, and more particularly to random number generation based on temporal characteristics of registered events of a random process.

Various applications, particularly in the field of secure communications, require the production of truly random numbers at a high bit-rate. Current random number generators (RNGs) typically employ complicated, yet ultimately deterministic, calculations, generating numbers that are, at best, pseudo-random. Other methods employ the inherent, and essential, randomness of quantum processes, since, in accordance with the laws of physics, there is no way, even in theory, to find a pattern within random numbers generated from quantum measurement. Such methods include radioactive decay (see, for example, U.S. Pat. No. 6,745,217, to Figotin, et al., issued Jun. 1, 2004), or the use of thermodynamic processes such as diode current fluctuations or Johnson noise measured on the voltage across a resistor (see, for example, U.S. Pat. No. 6,571,263, to Nagai, issued May 27, 2003). A further method (U.S. Pat. No. 6,609,139, to Dultz et al., issued Aug. 19, 2003) uses outputs of a beam splitter to establish random numbers from the path of a photon. A commercial implementation is sold by id Quantique S. A. of Carouge, Switzerland.

Single-photon counters typically have a maximum rate of detection beyond which they do not operate, thus limiting the photo-detection rate. Existing optical quantum random number generators produce at most one random bit per photo-detection event, and are therefore limited to generating random numbers at the maximum photo-detection rate. It is therefore desirable to enable a random number generator capable of extracting multiple bits of information from a single photo-detection event.

### SUMMARY OF THE INVENTION

In accordance with preferred embodiments of the present invention, a method is provided for generating random numbers. The method includes steps of registering a detection event from a random process, identifying a particular time segment from among a set of time segments, in which the event is registered, associating a value with the identified time segment, and outputting a random number based at least upon the associated value. In particular, the event may be the detection of a photon or another particle, and the method may additionally include the step of providing a source of particles such as, more particularly, photons.

In accordance with alternate embodiments of the invention, the intensity profile of the source of photons may be shaped as a function of time, and, more particularly, the intensity profile of the source of photons may be chosen in such a manner as to provide a specified distribution of photon detections, such as a flat distribution, or a Gaussian, or a substantially Poissonian distribution. Indeed, the temporal shape of the intensity profile of the source of photons may be chosen in such a manner as to maximize the number of random bits generated per photo-detection event.

In accordance with further alternate embodiments of the invention, the method may have an additional step, namely a step of removing bias from a set of outputted random numbers. The method may also have steps of attributing a value to a case in which no events are registered during a specified clock interval, or of dividing potentially detectable events between multiple detectors to gain additional random bits per event (e.g., using beam splitters to send incident photons to multiple detectors).

In accordance with another aspect of the invention, an apparatus is provided for generating random numbers. The apparatus has a photon detector, and a timer for identifying, relative to a fiducial time, a time segment (from a set of time segments) in which a photon is detected by the photon detector. Finally, the apparatus has a circuit for associating a value with the identified time segment and for outputting a random number based at least upon the associated value.

### BRIEF DESCRIPTION OF THE DRAWINGS

The foregoing features of the invention will be more readily understood by reference to the following detailed description, taken with reference to the accompanying drawings, in which:

FIG. 1A is a schematic depiction of prior art random number generator based on the quantum uncertainty as to the path taken by a photon through a beamsplitter;

FIG. 1B depicts an heuristic embodiment of the invention, wherein paths of different temporal latency are designed to provide substantially equal probability of traversal by a photon;

FIG. 1C depicts a further heuristic embodiment of the invention, wherein multiple paths of different temporal latency are designed to provide substantially equal probability of traversal by a photon, thereby providing multiple random bits per detected photon;

FIG. 2 is a schematic depiction of a preferred embodiment of the present invention;

FIG. 3A shows an exemplary plot of the intensity versus time of a light source, while FIG. 3B shows the resulting probability that a photon, of the pulse of FIG. 3A, will be first detected in a specified temporal bin and not before; and

FIG. 4A shows a further exemplary, and preferred, plot of the intensity versus time of a light source, while FIG. 4B shows the resulting probability that a photon, of the pulse of FIG. 4A, will be first detected in a specified temporal bin and not before.

### DETAILED DESCRIPTION OF SPECIFIC EMBODIMENTS

Random numbers can be extracted from a quantum system by measuring the quantum system in a basis in which the system is not in an eigenstate (but, rather, in a ‘superposition’ or ‘mixed’ state). The number of bits which can be extracted depends on the dimensionality of the Hilbert-space characterizing the quantum system, the ability of the detector to resolve the bases in Hilbert space, and the state of the quantum system, in particular, the likelihood of each of the resolvable quantum states.

Typically, random number generators (RNGs) based on photon detection use single-(qu)bit Hilbert spaces, i.e., they are characterized by a single quantum variable: polarization, path choice at a beam splitter, or photon number. (It should be noted that, while photon number has a theoretically infinite dimensionality, most current detectors cannot count photon numbers greater than 1, so only have two resolvable outputs corresponding, respectively, to the detection of one or more photons, or the detection of no photons.) In accordance with preferred embodiments of the present invention, it is the arrival time of photons that is measured, thereby generating multiple random bits per detection.

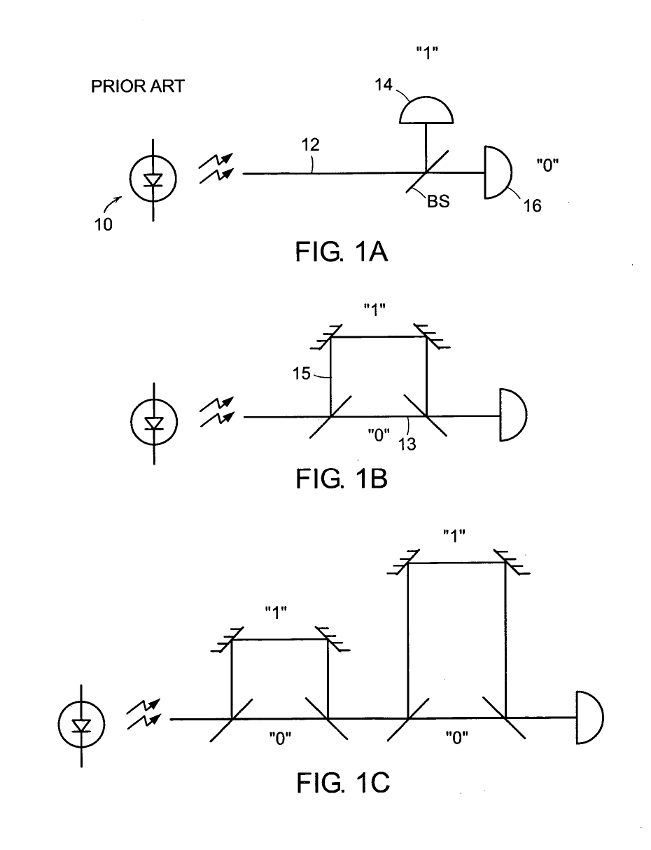

Referring first to FIG. 1A, a prior art method is shown schematically for generating random numbers using photons. A photon from some light source 10, such as a light-emitting diode (LED), for example, is directed along path 12 onto a 50-50 beamsplitter BS. Single-photon detectors 14 and 16 in the two output ports of beamsplitter BS register whether the photon was transmitted through beamsplitter BS (indicating a “0”) or reflected (indicating a “1”). The randomness of the scheme arises from the quantum mechanical uncertainty as to which way the photon will go at the 50-50 beamsplitter. Note that in this scheme at most one random bit may be obtained per photon, or more accurately, per photo-detection event.

In accordance with one embodiment of the present invention, a random value may be derived from detection of a photon using a single detector, as now described with reference to FIG. 1B. Here, a pulsed light source 10 emits a photon which is given two paths to travel to detector 14, path 13 or path 15. The difference in traversal time, Δt=Δx/c (where Δx is the difference in path length, and c is the speed of light) of these paths is greater than the time resolution of detector 14, so that an “early” detection corresponds to a “0”, while a “late” detection corresponds to a “1”. (The fact that sometimes the photons will leave the second beamsplitter traveling downward, never making it to the detector, is irrelevant: the intensity of the source can simply be increased to compensate for this effect. Alternatively, a second detector could be placed to detect these photons, yielding 2 bits per photo-detection event: one bit corresponding to which detector detects the photon, and a second bit corresponding to the time of detection.)

It is apparent how the time-bin random bit generation of FIG. 1B may be generalized to multiple bits. One method, depicted schematically in FIG. 1C, entails adding further two-choice time delays. As long as the time differences between each of the two-choice delays is greater than the detector resolution time, one obtains a resolvable bit for each individual two-choice time delay section. Thus, by using N such sections, N random bits may be generated for each photo-detection event. And, as in the case described in the foregoing paragraph, additional detectors might be used to monitor the other output ports, thereby yielding additional bits.

Though conceptually straightforward, the previous scheme has three main drawbacks. First, it requires a number of well aligned optical elements, or, otherwise, fiber-optic components, to create the various two-time delay sections. Second, the time to generate each bit must be at least as large as the time resolution of the detector. Third, it is necessary to know when the photon is created.

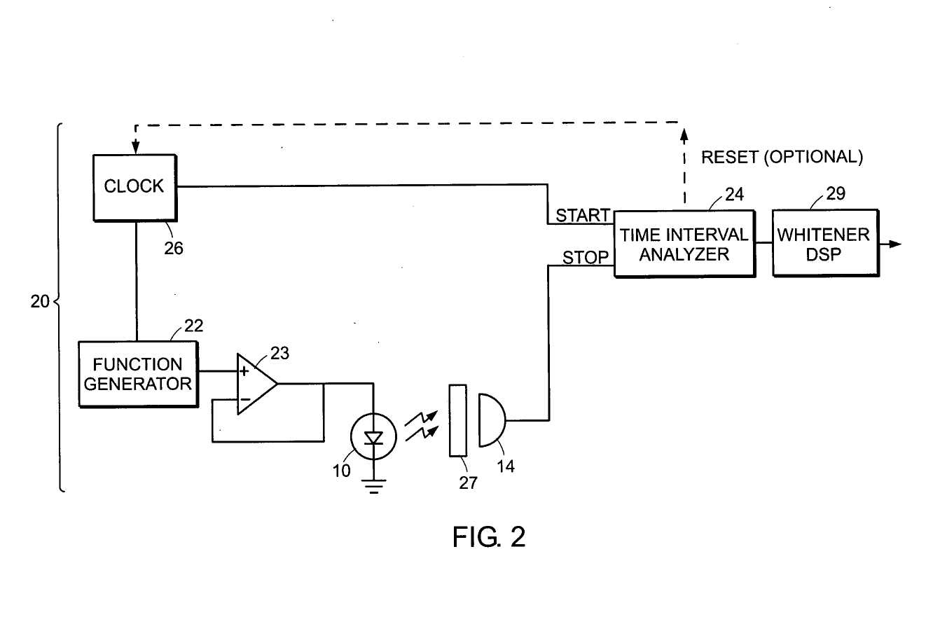

A preferred method of practicing the present invention is now described with reference to FIG. 2 wherein a Random Number Generator, designated generally by numeral 20, is depicted schematically. An optical pulse, which can be relatively long and the shape of which will be discussed in greater detail below, is produced by light source 10 (shown, by way of example, as an LED), as driven by a function generator 22. Other light sources, such as a fast laser diode, are also encompassed within the scope of the present invention, however light source 10 may be referred to herein as an ‘LED’, without limitation.

A Time Interval Analyzer (TIA) 24 records precisely where in that pulse the photon is detected by detector 14. This system is synchronous (based on a clock 26) and gives a fixed number of random bits per clock cycle. Thus, the clock generator 26 controls the rest of the apparatus, firing every T₀ seconds. A signal from the clock generator 26 starts two processes. First, it triggers the “Start” control on the time-interval analyzer. This triggering event may be referred to herein as a “fiducial time reference.” In accordance with various embodiments of the present invention, the TIA may be a time-to-amplitude converter (TAC), or, alternatively, it may be a digital counter using interpolation or vernier techniques to achieve high time resolution, as known to persons skilled in the digital circuitry art. Additionally, clock generator 26 triggers function generator 22 to begin generating an electrical signal used to drive light source 10.

The output of function generator 22 is a voltage signal, converted by a trans-impedance amplifier 23 to drive the LED, which is driven by a current source. (While the transimpedance amplifier is shown as an active circuit element, it is understood that any driving circuit appropriate to drive light source 10 is within the scope of the invention as described and as claimed in any appended claims. Indeed, if the LED current is small, and the output voltage of function generator 22 is sufficiently higher than the bias voltage of the LED, a simple resistor may serve to provide a current source to drive the LED.) Light from LED is typically attenuated by a filter 27, down to near the single-photon level, which is to say that only a few photons impinge upon detector 14 in a given clock cycle. The photons are detected by single-photon detector 14. “Single-photon” denotes the sensitivity of the detector to single photons of a wavelength emitted by source 10. Detector 14 may be an avalanche photodiode (APD), for example, or a photomultiplier tube (PMT). When detector 14 registers a photon, it generates an output pulse, which is fed to the “Stop” input on TIA 24. The TIA then generates a digital representation of the time interval between the Start and the Stop pulses received, and also, possibly, a special symbol for the case of No-photons-detected-in-the-interval.

If the timing resolution of the system is Tᵣ seconds, there are N=(T₀/Tᵣ) resolvable time intervals, enabling log₂(T₀/Tᵣ) binary bits of random data to be derived per detected photon.

Within the scope of the present invention, the bin size need not be greater than the time resolution of the detector itself, but merely greater than the resolving time of the post detector electronics. This is an extremely important distinction, as the detector resolution time is typically about one nanosecond, while the electronic resolution time can be much less, e.g., 10 picoseconds. This increases the number of random bits obtainable from each photo-detection.

In general, there may be some bias, and not all of the N outcomes will be equally likely. To correct this, the digital output is fed to a “whitening” step, performed by circuitry denoted as “Whitener Digital Signal Processor” (DSP) 29. In the whitening step, standard hashing functions are used to remove any bias by outputting a smaller number of bias-free random bits. The total maximum number of random bits extractable from the N possible outcomes is given by the von Neumann entropy:

$$S = - {\sum }_{i = 1}^{N} {P}_{i} * {log}_{2} ( {P}_{i} ) ,$$

where Pᵢ is the probability of output condition i.

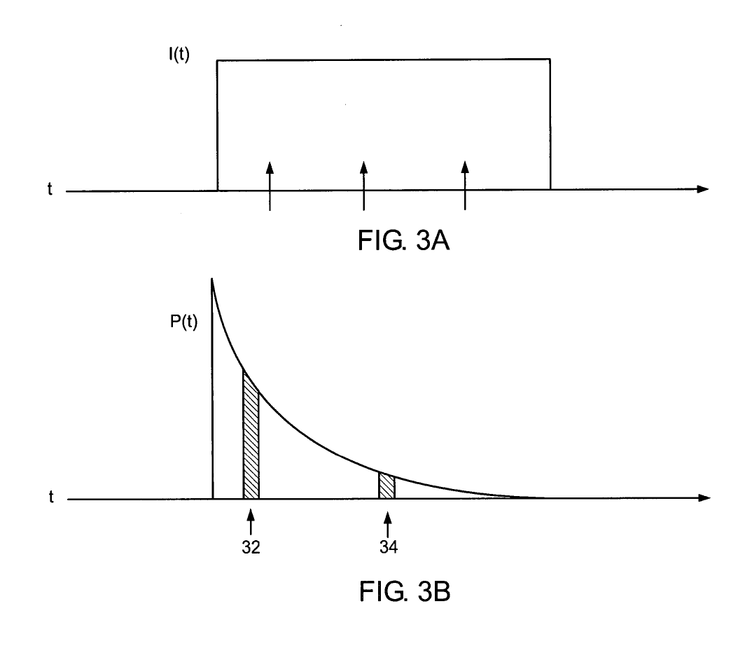

The shape of the waveform I(t) used to drive the LED can affect the probability distribution P(i) of detected photons. If a constant current source is used, as depicted in FIG. 3A, the photons will obey Poisson statistics, i.e., the probability p of having one photon in any specific time bin is independent of whether photons were in any of the other time bins. The probability of having the first detection in the i-th time bin is then Pᵢ=(1−p)ⁱ⁻¹p. This function, depicted in FIG. 3B, decreases with i, i.e., it is more likely for the first detection to happen earlier (in bin 32, for example) rather than later (in bin 34).

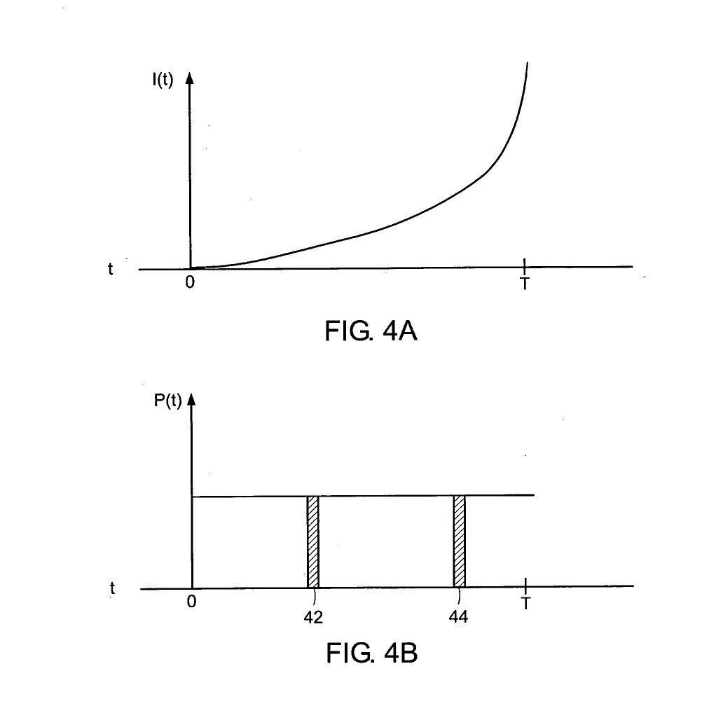

The foregoing imposes an upper bound on the entropy S that can be extracted, relative to the number of bins. However, one can use a shaped intensity profile to overcome this difficulty. For example, referring now to FIG. 4A, if function generator 22 (shown in FIG. 2) outputs an approximation of the function

$$I ( t ) = {I}_{0} \frac{{T}_{0}}{{T}_{0} - t} ,$$

where I₀ is an adjustable parameter dependent on the light source, then the resulting Pᵢ function, shown in FIG. 4B, is such that all outcomes (e.g., bins 42 and 44) are approximately equally likely. The whitening step now only slightly reduces the bit rate, and one can achieve a near-maximal number of random bits per detected photon.

The attenuation of the LED source is set to optimize the random bit rate. Too little attenuation will cause more frequent detection in the “early” sub intervals, leading to excessive bias (some outcomes more likely than others). Too much attenuation, and many intervals will have no detection events at all, greatly reducing the random bit rates.

The exact setting of the attenuator obviously depends on the shape of the distribution desired. For the flat distribution, the correct intensity of the 1/(T−t) function is such that the probability of detecting 1 photon in the nth interval is 1/(N−n). This function cannot be integrated, but if clamped at a reasonable level gives an average photon number of about 5 per pulse.

With a constant intensity profile, the power level should be adjusted to maximize the Von Neumann entropy. The solution depends on the number of sub-intervals; for a system with 4096 bins (2¹²), the correct intensity corresponds to about 3.33 photons per interval, and leaves about 11 bits of actual entropy available for extraction by whitening, i.e., ˜11 bits per photodetection event.

The intensity curve I(t) of FIG. 4A rises towards infinity near the end of the clock interval T₀ in order to ensure that at least one of the output detection bins is full. Effectively, it makes the probability of photon detection in the last ‘bucket’ equal to 1, even if no photons were detected in any of the previous N−1 bins. However, it is not practical to generate infinite or large currents, which would burn out the LED and/or photon counter. Therefore, rather than actually driving the LED during the final time element, instead, if we do not detect a photon in the first N−1 time increments, the TIA outputs the default value N.

When N is large, this also requires high current and high current slew rate in the last few sub-intervals, which are difficult to produce. Instead, we may use an alternate function that provides more randomness than the constant-current source, but less stringent demands on the function generator/amplifier combination. For example, in one embodiment of the invention, a constant drive may be applied during these last few bins.

Alternatively, other drive functions I(t) may be used within the scope of the present invention. While the use of other drive functions may have the effect of making some of the outcomes less likely than others and increasing the likelihood of no detection in a cycle, these problems can easily be accounted for in the whitening step, with only a modest reduction in bit rate, retaining more randomness than the constant-current source and the generation of 1 bit per photon that is already available using prior art methods. Moreover, it is desirable, in certain applications, to provide for a tailored probability distribution such as a Gaussian or Poisson distribution, etc. In such cases, the temporal shape of the intensity profile I(t) of the source of photons may advantageously be tailored to produce random numbers accordingly.

The intensity profile needed to generate a random distribution P(t), where P(t) is the probability density of detecting the first photon in an interval at time t, is given by: R(t)=P(t)/(1−∫₀ⁱP(t′)dt′). Here R(t) is the average detection rate at time t; thus, the rate of photon emission should be R(t)/η, where η is the net detection efficiency. In general, the integral ∫₀ⁱP(t′)dt′ will not be analytically solvable (for instance, a Gaussian distribution gives an Error function). It is, however, entirely sufficient to numerically compute this integral. Note that if the value of the integral is 1, then R(t) diverges at time t; however, as indicated previously, by relaxing the requirement for 100% detections per interval, this can be constrained to a reasonable maximum. Also, integrating R(t) over the range [0,T] will usually give a result greater than 1, since sometimes multiple photons will be produced (but not counted) within one interval.

LEDs may be used for light source 10 because they may be rapidly modulated and are very nearly linear devices, as opposed to laser diodes (which are only linear above threshold) or thermal lamps (which are neither linear nor fast). However, LEDs are not exactly linear, either. In accordance with an alternate embodiment of the invention, it is possible to compensate for this non-linearity by adding feedback via a photo-diode. Part of the beam can be picked off before attenuation to the single-photon level and fed back to the driving amplifier as an error signal. This will cause the amplifier to adjust the output current so that the output light is proportional to the input signal.

The photon counter may be damaged by excessive detections. The average number of photons detected from this pulse will be greater than one, if the APD is allowed to recover before the end of the cycle. To reduce this problem and allow higher clock rates, we can turn off the LED after the stop pulse arrives, or use a gating circuit on the detector to shut it off. While the system works without this optimization, it advantageously allows a higher bit rate.

Once a photon is detected by detector 14, the apparatus will sit idle for the remainder of the T₀ time. Since each bin has equal probability of first detection assuming the drive function

$$I ( t ) = {I}_{0} \frac{{T}_{0}}{{T}_{0} - t} ,$$

the system will be idle approximately half the time. Instead, the detection signal could cause the clock and the function generator to reset, so they start again immediately. This does not actually permit an increase in the overall detection rate, since that is the limiting factor to begin with. However, resetting the clock upon detection allows using twice as many detection windows per photon, and thus increases the total random bit rate by approximately 1 per photon. To see this more clearly, consider a detector average saturation rate of 1 MHz, and time resolution of 1 ns. One can either run the system synchronously at 1 MHz, obtaining N=1000, or one can run the system at ˜500 kHz with detection-initiated resets (so that the average detection rate is still 1 MHz), corresponding to N=(2 μs)/(1 ns)=2000 resolvable time bins per photodetection. The cost is that the system is no longer synchronous—random numbers will be output at non-deterministic times. However, an additional storage buffer may be used, in accordance with alternate embodiments of the invention, in order to regulate the output.

APDs (and to a lesser extent PMTs) have a “dead time”, a minimum time after receiving a pulse before another may be efficiently detected; and an afterpulsing probability, the probability of generating a second “detection” shortly after the dead-time interval, without seeing another photon. These effects, if not considered, will generate correlations between the outputs of adjacent intervals, possibly compromising the randomness of the source. Thus, some additional “quiet time” window is preferably inserted between cycles to allow the detector to recover while any afterpulses occur.

Detector dark counts have little deleterious effect on practice of the invention as herein described since such counts are also random, and since their rate of occurrence in most Si APDs is very low anyway (˜100 counts per second, compared to the anticipated typical detection rates, greater than 106 counts per second).

In one exemplary embodiment of the invention, a Function/Arbitrary waveform generator (for example, an Agilent Model 33250) provides a Sync signal to be used as the start pulse, and generates arbitrary waveforms with up to 80 MHz bandwidth. This can easily provide an excitation curve, substantially as prescribed, at the 1 MHz repetition rate. At typical operating light levels, this will give about 3 million photons per second incident on the photodetectors, which is the level where, e.g., a Perkin-Elmer single-photon counting module (SPCM AQR-14) starts to saturate. The PicoQuant TimeHarp200 is a time-interval analyzer that can do 3 million conversions per second with 40-ps/channel resolution, and measure up to 2¹² bins (4096).

Without detector gating, this selection of components is capable of operating with a clock rate of 1 MHz and a TIA interval of approximately 200 ps (to give 4096 bins per microsecond), thereby generating ˜12 million random bits per second, prior to whitening. If detector gating is implemented to control saturation of the detectors, the detectors can be run up to the 3 MHz repetition rate, for ˜36 million random numbers per second.

The embodiments of the invention heretofore described are intended to be merely exemplary and numerous variations and modifications will be apparent to those skilled in the art. In particular, while the invention has been described in the context of photon detection, it is to be understood that the invention may advantageously be applied to any quantum process used for random number generation, wherein, time resolution of the detection of a event is further implemented, in accordance with the teachings herein, in order to achieve greater rates of random bit generation. All such variations and modifications are intended to be within the scope of the present invention as defined in the appended claims.

What is claimed is:

1. A method for generating random numbers, the method comprising:
a. registering an event characterizing a random process;
b. identifying, from among a set of time segments, a time segment in which the event is registered, the time segment identified relative to a fiducial time;
c. associating a value with the identified time segment; and
d. outputting a random number based at least upon the associated value.

2. A method in accordance with claim 1, wherein the time segment in which the event is registered is a time segment in which a particle is detected.

3. A method in accordance with claim 2, wherein the particle is a photon.

4. A method in accordance with claim 2, further comprising a preliminary step of providing a source of particles.

5. A method in accordance with claim 4, wherein the step of providing a source of particles includes shaping the intensity profile of the source of particles as a function of time.

6. A method in accordance with claim 5, wherein the temporal shape of the intensity profile of the source of particles is chosen in such a manner as to provide a specified distribution of particle detections.

7. A method in accordance with claim 6, wherein the specified distribution of particle detections is flat.

8. A method in accordance with claim 6, wherein the specified distribution of particle detections is substantially Gaussian.

9. A method in accordance with claim 6, wherein the specified distribution of particle detections is substantially Poissonian.

10. A method in accordance with claim 5, wherein the temporal shape of the intensity profile of the source of particles is chosen in such a manner as to maximize the number of random bits generated per photo-detection event.

11. A method in accordance with claim 1, further comprising a step of removing bias from a set of outputted random numbers.

12. A method in accordance with claim 1, further comprising a step of attributing a value to a case in which no events are registered during a specified clock interval.

13. A method in accordance with claim 1, further comprising a step of using beam splitters and extra detectors to gain additional random bits per registered event.

14. An apparatus for generating random numbers, the apparatus comprising:
a. a particle detector;
b. a timer for identifying, relative to a fiducial time, a time segment in which a particle is detected by the particle detector, the time segment comprising one of a set of time segments; and
c. a circuit for associating a value with the identified time segment and for outputting a random number based at least upon the associated value.

15. An apparatus in accordance with claim 14, wherein the particle is a photon and the particle detector is a photon detector.

16. An apparatus in accordance with claim 14, further comprising a source of particles.

17. An apparatus in accordance with claim 16, wherein the source of particles is a light-emitting diode.

18. An apparatus in accordance with claim 16, wherein the source of particles is a laser diode.

19. An apparatus in accordance with claim 15, wherein the photon detector is an avalanche photodiode.

20. An apparatus in accordance with claim 15, wherein the photon detector is a photomultiplier tube.

21. An apparatus in accordance with claim 16, further comprising a feedback circuit for governing emission of the source of particles based on detection of particles that are emitted by the source.
